(19) United States
(12) Patent Application Publication
(10) Pub. No.: US 2005/0279698 A1
(43) Pub. Date: Dec. 22, 2005

(54) Integrated cooker-strainer

(76) Inventor: David Scott Kleinman, Twinsburg, OH (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/869,773

(22) Filed: Jun. 16, 2004

(51) Int. Cl. B01D 29/88

(52) U.S. Cl. 210/470; 210/464; 210/465; 210/469; 210/477; 99/352

(57) ABSTRACT

An integrated cooker-strainer system for food preparation. The device includes a pot assembly operatively associated with a strainer assembly. The integrated system has a first position wherein a handle and container of the strainer assembly is substantially engaged in a handle and container of the pot assembly. In both the first and second position, a sealed mating portion between the strainer and pot maintains contact between the surfaces, preventing the leakage of liquid at this point. The integrated system may be used for a variety of other purposes, for example, as a meat strainer, colander, steamer, and produce shaker. The integrated system may be used for baking, microwave or stovetop cooking. A hand-operated pressing mechanism can be employed to accelerate drainage of liquid from food.

### TECHNICAL FIELD

The present invention relates generally to devices used in the food preparation industry, and more particularly to a device integrated for use as both a cooker and a strainer.

### BACKGROUND OF THE INVENTION

The food preparation industry is rapidly expanding and developing to adapt to the modem needs of individuals and families. More people are working outside the home than ever before, thus, there is less time to prepare home cooked meals.

People that prepare home cooked meals face difficult problems during preparation, cleanup and storage. Preparation of even simple meals often requires a large number of utensils and cooking equipment. Moreover, each utensil and piece of equipment requires thorough cleaning after meal preparation. In addition, each utensil and piece of equipment requires storage capacity to stow such equipment while not in use. Modem food preparation products provide functional requirements while attempting to integrate more features and uses into a single product.

Foods requiring drainage of fluids, such as water, grease, etc., typically require at least two separate pieces of equipment. First, the cook prepares the food, by cooking, marinating, rinsing, etc, in one pot or bowl. Then the cook transfers the food to a separate strainer to remove the liquid. If the food was cooked or marinated, the cook moves the cooking pot from a stove, microwave, or refrigerator to a strainer, normally placed in a sink. Moving the cooking pot may result in droplets of grease, water, or other fluids, to fall onto the surface over which the cooking pot is moved. These droplets on a countertop, floor or other surface, create both a messy and a dangerous condition. The droplets, if not removed, may lead to food-borne and air-borne diseases, such as E.coli or salmonellosis, etc. In addition, if droplets or the like are on the floor, the cook, or others could slip and fall.

Adding to this messy and dangerous condition, the cook must now transfer the food from the cooking pot to the strainer. Ordinarily the strainer is placed in a sink and the cooking pot is moved over the strainer. The cook turns the cooking pot upside down over the strainer and the food falls from the cooking pot to the strainer. If the cook transfers the food and liquid too quickly, the liquid may splash onto the cook's face or body, or onto the surrounding countertop and floor. In addition, the food itself may not fall directly from the pot to strainer and may land in the sink, on the floor, or other undesired locations.

Some foods, such as spinach, require pressing the food in a sieve to remove as much liquid as possible. This necessitates an additional component which some cooks do not have readily available. Thus, the task of preparing these foods becomes burdensome and undesirable.

In order to fulfill the changing needs of cooks, food preparation products must be integrated to perform multiple functions, while reducing problems associated with preparing foods.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to an integrated cooker-strainer system that provides for fully and independently functional cooker and strainer respectfully that also work in conjunction to provide for advantages over conventional cookers and strainers. More particularly, the handles and circumferential portions of the cooker and strainer in accordance with the subject invention mate so as to allow a user to cook items in the cooker and when the items are at a stage for straining to move the cooker coupled with the strainer to a drain area and rotate the integrated cooker and strainer so as to drain the items in the drain area and avoid issues of spillage that conventional strainers introduce. The handles and circumferential regions of the cooker and strainer mate so as to form an ergonomic integrated device/system that is easy to hold, mitigates leakage at undesired portions and facilitates an overall cooking process.

In accordance with one particular embodiment of the invention, an integrated cooker-strainer system includes a first handle and a second handle. The first handle is attached to a first container (e.g., cooker) and the second handle is attached to a second container (e.g., strainer). The second container has a plurality of openings allowing fluid to pass through. Around a perimeter of the first handle and first container is a first lip portion, having first and second sides. Around a perimeter of the second handle and second container is a second lip portion, having first and second sides. The second container has a first position and second position. In the first position, the first container substantially surrounds the second container and the first handle engages the second handle. In the first position, the first side of the first lip portion and the second side of the second lip portion are connected. When the second container is in the second position, the first side of the first lip portion and the first side of the second lip portion are connected. The present invention can optionally incorporate a hand-operated pressing mechanism to squeeze additional liquid or grease out of the food. The present invention can also incorporate a lid selectively engaging the second container to cover the food.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an integrated cooker-strainer system having a hand-operated pressing mechanism in accordance with an aspect of the present invention.

FIG. 2 illustrates a top view of an integrated cooker-strainer system having a hand-operated pressing mechanism in accordance with an aspect of the present invention.

FIG. 3 illustrates a cross sectional side view of an integrated cooker-strainer system taken along line 4-4 of FIG. 2.

FIG. 4 illustrates a cross sectional side view of an integrated cooker-strainer system taken along line 3-3 of FIG. 2.

FIG. 5 illustrates an integrated cooker-strainer system in accordance with an aspect of the present invention.

FIG. 6 illustrates a cross sectional side view of an integrated cooker-strainer system having a cooking lid in accordance with an aspect of the present invention.

FIG. 7 illustrates a side view of an integrated cooker-strainer system in accordance with an aspect of the present invention, wherein a strainer is in a second position.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details.

The present invention provides an integrated cooking system configured to operate as both a cooker and a strainer. The integrated system provides for convenient and efficient food preparation. The integrated cooker-strainer system can be used for a variety of food preparation tasks including, a meat strainer, colander, produce shaker and steamer.

FIG. 1 illustrates an integrated cooker-strainer system 110 in accordance with an aspect of the present invention. The integrated system 110 includes a strainer assembly 112 coupled with a cooker assembly 114. The strainer assembly 112 and cooker assembly 114 are separate assemblies designed for use as an integrated system; however, they may be used separately, if desired. The strainer assembly 112 and cooker assembly 114 can be made from a variety of materials, such as plastic, ceramic, copper, glass, stainless steel, aluminum, cast iron, etc. To facilitate food removal and cleaning ease, the material may be coated with a non-stick surface coating, such as Teflon®.

With reference to FIGS. 1-5, the cooker assembly 114 has a container or pot 120. Although the pot 120 shown resembles a typical saucepot, it is to be understood and appreciated that any pot configuration may be used. For example, a deep-sided frying pan assembly could be employed on an integrated system 110. Additionally, while the pot may be any depth, the walls should be of sufficient height to receive a strainer container 142, which will be discussed in more detail below.

The bottom of the pot 120 may be flat allowing it to sit level on a surface, such as, for example, a countertop or stove. The flat bottom provides stability to the integrated cooker-strainer system 110, reducing the possibility of the integrated system 110 being knocked over accidentally and spilling the food contents onto a surface or a person and creating a hazardous condition.

The cooker assembly 114 has a handle 116 connected to the pot 120. The handle 116 and pot 120 may be integrated as a one-piece unit. Alternatively, the handle 116 and pot 120 may be separate pieces that are attachable, provided the attachment is durable. Even though a cooker assembly 114 with one handle 116 is shown, it is to be understood and appreciated that there may be more than one handle. For example, the cooker assembly 114 may have one handle on one side of the pot 120 and a second handle on the opposite side of the pot 120. This configuration would allow a cook to lift and carry larger or heavier integrated assemblies with both hands, each hand on either side of the pot.

Although an oblong handle 116 is shown, it is to be understood and appreciated that any handle configuration can be used in accordance with an aspect of the present invention. For example, a half-circular handle or a rectangular handle could be employed on an integrated system 110. Additionally, the width and length of the handle 116 could vary from those depicted in FIGS. 1-7 of the present invention. It is to be appreciated and understood that the handle design may be altered depending on the size and weight of the corresponding pot 120.

The handle has a top portion 126 and a bottom portion 128. The top portion 126 may be wider than the bottom portion 128 and taper toward the bottom portion 128. The handle 116 may be concave with an edge, rim or lip portion 124 around the outside perimeter of the top portion 126. Thus forming, for example, a U-shaped handle, with the top portion 126 delineating the upper part of the “U” and the bottom portion 128 delineating the lower, semi-circular portion of the “U.” The underside of the handle may have ridges or grip portions for the cook's fingers, providing a secure, non-slip relationship between the cook's hand and the handle 116.

With continuing reference to FIGS. 1-5, the pot 120 has a ridge or lip portion 132 extending substantially around its entire upper perimeter. The pot lip portion 132 connects or is integrally formed with the handle lip portion 124. The handle 116 may be flush mounted to the pot 120 allowing the lip portion 124 to extend around the outer edge and the sides of the top portion 126 and continue around the ridge portion 132 of the pot 120. However, the lip portions 124, 132 do not extend between the cooker handle 116 and the pot 120 (best seen in FIG. 5). This portion remains open to allow the cooker assembly 114. to engage a strainer assembly 112, which will be discussed further below. Thus, there is a continuous uniform mating or sealing surface 124, 132 around the outer perimeter of the cooker assembly 114, including the cooker handle 116.

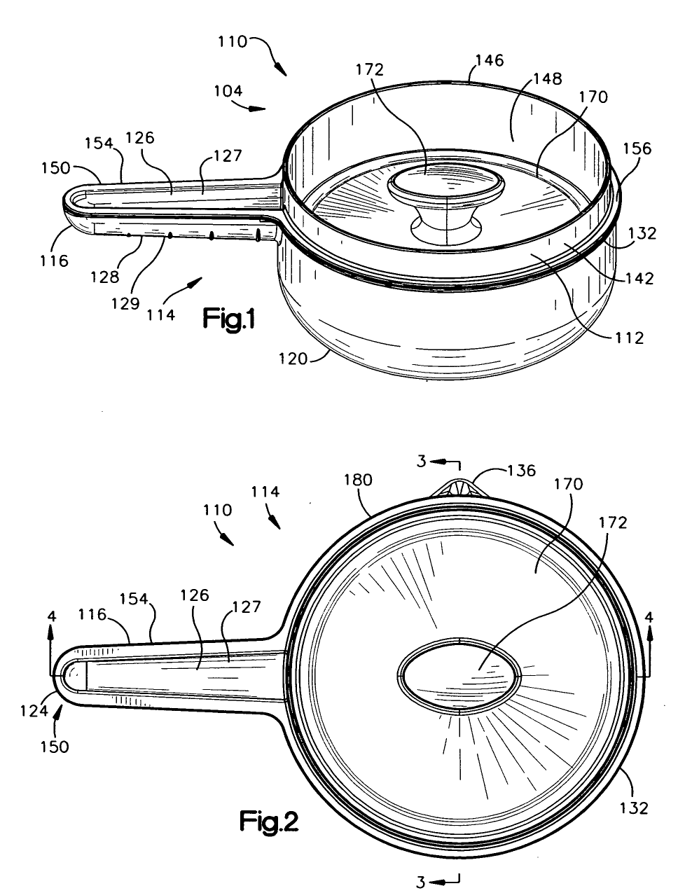

The uniform mating surface 124, 132 has a first side 180 and a second side 182. The first side 180 is the portion of the sealing surface 124, 132 around the upper rim or perimeter of the cooker assembly 114 and the second side 182 is the opposing side, or underside of the sealing surface 124, 132. By way of illustration, FIG. 2 illustrates a top view of the integrated system 110. The first side 180 is shown around the perimeter of the pot 120 and handle 116 combination. The second side 182 would be viewable if the cooker assembly 114 is turned upside down, looking at the cooker assembly 114 from the bottom.

Referring to FIGS. 2, 3, and 6, the cooker assembly 114 may have a spout or pouring area 136. The spout 136 is shown opposite the handle 116, however, it may be located anywhere on the pot 120. With the handle 116 flush mounted to the upper rim of the pot 120 provides ease of pouring.

With reference now to the strainer assembly 112 and FIGS. 1-5, the strainer assembly 112 has a handle 150 and a container or bowl 142, which may be integrally formed as one piece, or it may be a combination of two pieces. The strainer handle 150 is not located at the upper rim of the strainer container 146. Rather the handle 150 is attached to the container 142 slightly below the container's upper rim 146. This placement limits the depth to which the strainer container may be placed into the cooker assembly.

Although an oblong handle 150 is shown, it is to be understood and appreciated that any handle configuration can be used in accordance with an aspect of the present invention. The handle design may be altered provided the strainer handle 150 is substantially the same shape and size as the pot handle 116. For example, a half-circular pot handle can be utilized with a half-circular strainer handle 150. Additionally, the width and length of the handle 150 could be different than the handles depicted in FIGS. 1-7 of the present invention. The number of strainer handles can correspond with the number of pot handles.

The strainer handle 150 has a first side 127 and a second side 129. Such a configuration can allow handle 150 to be concave with a first side 127 being wider than the second side 129. The handle may form, for example, a U-shaped handle, with a rim or lip portion 154 around the outer perimeter of the first side 127 delineating the upper part of the “U.” The handle second side 129 delineates the semi-circular lower portion of the “U.” It should be noted that the lip portion 154 does not extend between the strainer container 142 and the strainer handle 150.

The strainer container 142 has a ridge or lip portion 156 slightly below the container's top or upper rim 146. This placement corresponds with the position of the strainer handle 150 to provide a continuous uniform lip surface 154, 156 around the outside perimeter of the strainer assembly 112. The uniform lip portion 154, 156 of the strainer assembly 112 has a first side 184 and a second side 186. The first side 184 is the upper portion of the uniform lip portion 154, 156 that corresponds with the upper rim of the strainer 146. The second side 186 is the underside, or opposite side of the uniform lip portion 154, 156.

The strainer container 142 may be the same depth as the cooker pot 120. In this way, the strainer assembly 112 and the cooker assembly 114 can hold the same amount of food, allowing the food to be transferred from the strainer to the pot and vice-versa. Since the strainer uniform lip portion 154, 156 is below the upper rim 146, when the strainer container 142 is placed inside the pot 120, the portion of the strainer container 142 above the uniform lip portion 154, 156 will remain outside the pot 120.

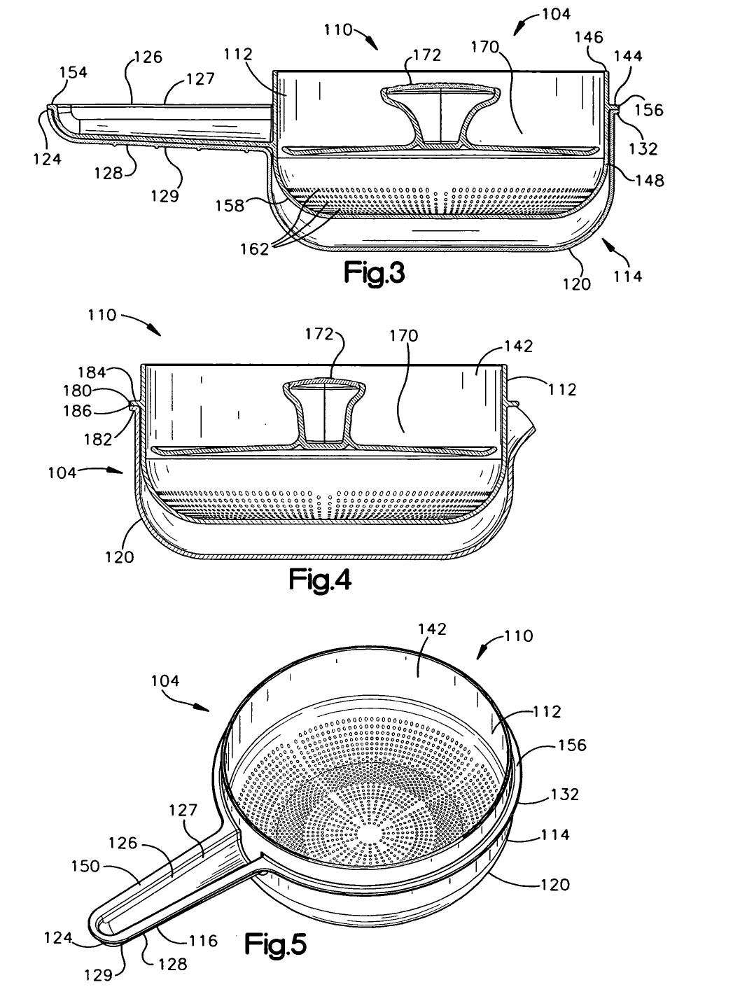

By way of further illustration, FIGS. 3 and 4 depict cutout views of the integrated system 110 taken along lines 4-4 and 3-3 of FIG. 2. The strainer container 142 has a lower portion 158 with a plurality of openings 162. The openings 162 provide an outlet for the liquid to drain from the food. While the plurality of openings 162 are shown at the bottom, it is to be understood and appreciated that openings 162 may be located at other areas, for example, on one or more sides of the strainer container 142. The openings may even extend substantially to the top of the strainer container 142.

As illustrated in FIGS. 1-6, in accordance with an aspect of the present invention, the integrated system 110 has a first position 104, wherein a strainer assembly 112 is substantially engaged within a cooker assembly 114. For example, a cook would place the strainer container 142 inside the cooker pot 120. In so doing, the cook would also insert the concave portion of the strainer handle 150 substantially inside the concave portion of the cooker handle 116. In effect, locking the handles 116, 150 together.

With both the strainer assembly 112 and cooker assembly 114 in this position, the first side of the pot lip portion 180 mates with the second side of the strainer lip portion 186. Mating of the two uniform lip portions provides a smooth secure mechanical interface between the assemblies 112, 114. Such an interface enables the cook to keep the strainer and pot together, thereby preventing liquids or food to escape from this contact point. Also, locking the handles 116, 150 together provides a single handle for moving the integrated system 110 from, for example a stove to a sink. The single handle keeps the strainer assembly in contact with the cooker assembly, thereby eliminating any problems associated with the strainer accidentally tilting inside the cooker assembly and spilling food over the rim of the strainer, which is a common problem cooks face when attempting to use a strainer not designed for the pot.

Referring to FIGS. 3, 4, and 6, in the first position 104 the portion of the strainer container below the uniform lip portion is within the pot. The upper portion of the strainer container 146 is not within the cooker pot 120. Rather, the strainer container is limited from extending completely into the cooker pot 120 because of the positioning of the strainer uniform lip portion 154, 156. Thus, the bottom of the strainer does not touch, or extend to, the bottom of the cooker pot 120. The space in the pot under the strainer provides an area for the fluid to seep out of the plurality of holes 162 and collect in the pot. The integrated system may be stored while in the first position 104, minimizing the space necessary to store the integrated system when not in use.

By way of illustration, with reference to FIGS. 1-6, a cook may place the strainer container 142 into the pot 120 by aligning the strainer handle 150 directly over the pot handle 116. The cook would push the strainer assembly 112 down into the cooker assembly 140, engaging the strainer handle 150 in the pot handle 116. This action would also selectively engage the first side of the pot uniform lip portion 180 with the second side of the strainer uniform lip portion 186.

The cook may then place food into the strainer container, and by virtue of this, into the cooker container. For food that requires cooking in liquid, such as, for example, spaghetti, the cook may fill the strainer and pot with water as well as food. The cook may then place the integrated assembly in a microwave or oven or on a stovetop. After the food is cooked, the cook would remove the strainer from the pot, by lifting the strainer handle 150 off the cooker handle 116, thus removing the strainer container 142 from the cooker pot 120 and allowing the liquid to drain out of the strainer, through the plurality of holes in the strainer and into the pot.

In the alternative, the cook may utilize the integrated system without cooking food. For example, food, such as lettuce, may be placed in the strainer container and rinsed, such as under a faucet. Then the strainer assembly may be placed in the first position in the cooker assembly. The cook may then allow the food to remain in the strainer, either covered or uncovered, for any amount of time desired and any liquid will drain off the food, through the plurality of holes in the strainer and settle into the pot. After the desired drainage time is over, the cook would remove the strainer from the pot and pour the liquid out of the pot.

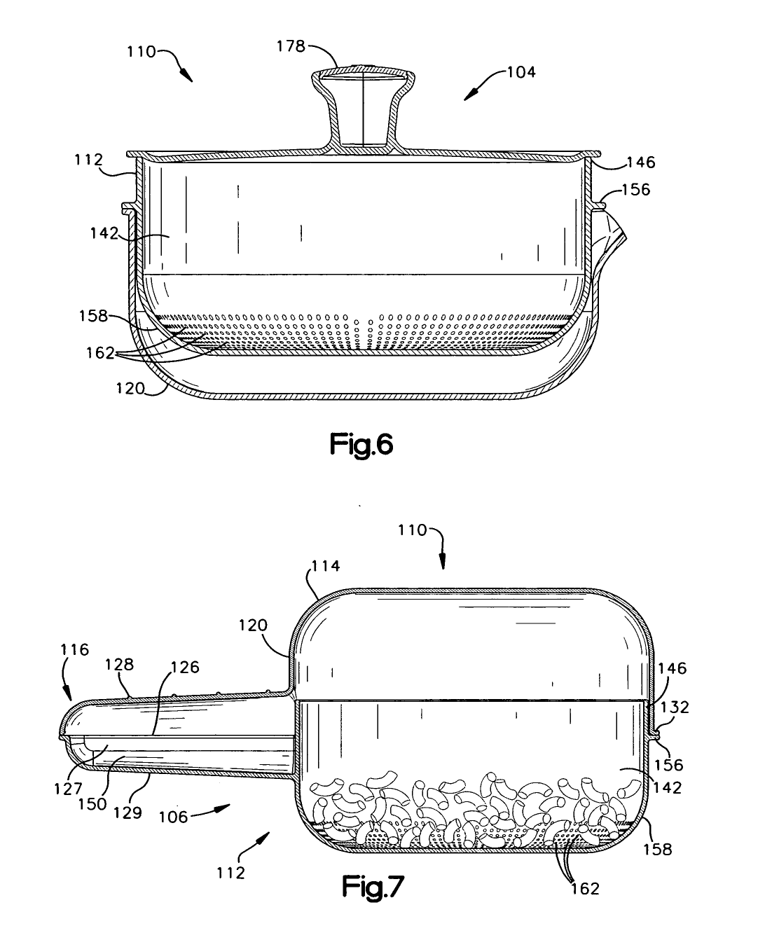

In accordance with another aspect of the present invention, FIG. 6 illustrates an integrated system 110 with an optional lid 178. When the integrated system 110 is in the first position 104, the lid may be placed onto the strainer container, covering the food.

In accordance with another aspect of the present invention, FIGS. 1-4 illustrate an integrated system 110 with a hand-operated pressing mechanism. The hand operated pressing mechanism consists of a flat portion 170 and a holding portion 172. The flat portion 170 may be circular, for example, corresponding to the shape of the strainer container 142. The flat portion 170 would be slightly smaller in diameter than the strainer container 142 allowing the hand-operated pressing mechanism to be inserted inside the strainer container 142. The flat portion 170 thickness would be sufficient to allow the pressing mechanism to be pressed into food without damaging the flat portion 170, such as by bending or distorting, etc. The holding portion 172 would allow a place for the cook to hold onto while pushing the hand-operated pressing mechanism down into the food.

By way of illustration, if the cook desires to press the food to remove additional liquid, while the integrated assembly is in the first position 104, the cook would place the hand-operated pressing mechanism 170 into the strainer container 142, over the food. The cook holds onto the holding portion 172 and pushes down. This pushes the flat portion 170 into the food, pressing the food and liquid down into the strainer container 142. Thus, any liquid, grease, etc. would be pressed out of the food via the plurality of holes 162 and into the pot 120. The hand-operated pressing mechanism 170 is useful to squeeze as much liquid out of the food as possible, such as, for example, cooked spinach. The pressing mechanism 170 also speeds up the drainage of liquid.

Referring now to FIG. 7, in accordance with another aspect of the present invention, the integrated system 110 has a second position 106, shown in FIG. 7, wherein the strainer assembly 112 is upside down or inverted over the cooker assembly 114. In this position, the handles 116, 150 mate at their respective lip portions 124, 154 and the containers 120, 142 mate at their respective lip portions 132, 156. In this way, when the integrated system 110 is in its second position 106 the first side of the cooker uniform lip portion 180 selectively engages the first side of the strainer uniform lip portion 184.

With reference to FIG. 7, a method of using the strainer assembly 112 in the second position 106 will now be described. A user cooks food, such as, for example, macaroni, in the cooker assembly 114. After the food is cooked, the user places the strainer assembly 112 in its second position 106 over the cooker assembly 114. The user engages the first side 180 of the uniform lip portion 124, 132 of the cooker assembly 114 with the first side 184 of the uniform lip portion 154, 156 of the strainer assembly 112. The user then holds both handles 116, 150 in engagement with each other and, over a sink or other container, turns the cooker assembly 114 and strainer assembly 112 combination upside down, allowing the liquid and food to fall from the cooker assembly 114 into the strainer assembly 112. Any liquid will then drain through the plurality of openings 162 in the strainer container 142 into the sink or other container. This method may also be used for foods that are not cooked, such as lettuce.

What has been described above includes exemplary implementations of the present invention. It is, or course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. An integrated cooker-strainer system comprising:
a cooker assembly comprising:
at least one handle connected to a container;
a lip portion around a perimeter of the cooker assembly;
a strainer assembly comprising;
a container comprising a plurality of openings;
at least one handle connected to the container; and,
a rim portion around a perimeter of the strainer assembly,
wherein the lip portion engages the rim portion.

2. The device of claim 1, the first lip portion, having a first side and a second side and the rim portion, having a first side and a second side.

3. The device of claim 2, wherein the integrated cooker-strainer system has a first and a second position.

4. The device of claim 1, wherein when the integrated cooker-strainer system is in the first position, the cooker container substantially engages the strainer container and the cooker handle engages the strainer handle.

5. The device of claim 4, wherein when the integrated system is in the first position, the first side of the first lip portion and the second side of the second lip portion are connected.

6. The device of claim 3, wherein when the integrated system is in the second position, the first side of the lip portion and the first side of the rim portion are connected.

7. The device of claim 1, further comprising a hand-operated pressing mechanism selectively engaging the second container.

8. The device of claim 1, further comprising a lid selectively engaging the second container.

9. An integrated system comprising:
at least one lifting mechanism connected to a pot;
at least one handle operatively connected to a container having a plurality of openings; and,
wherein the container and the at least one handle have first and second positions relative to the container and the at least one lifting mechanism.

10. The integrated system of claim 9, further comprising:
at least one sealing surface around a perimeter of the at least one lifting mechanism and pot, the at least one sealing surface having a first side and a second side; and,
at least one lip surface around a perimeter of the at least one handle and container, the at least one lip surface having a first side and a second side.

11. The integrated system of claim 9, wherein when the container and the at least one handle is in the first position, the at least one lifting mechanism engages the at least one handle.

12. The integrated system of claim 11, wherein when in the first position, the container is substantially inserted into the pot and the first side of the at least one sealing surface is connected to the second side of the at least one lip surface.

13. The integrated system of claim 10, wherein when in the second position the first side of the at least one sealing surface is connected to the first side of the at least one lip surface.

14. The integrated system of claim 9, further comprising:
a hand-operated pressing mechanism selectively engaging the bucket.

15. The integrated system of claim 9, further comprising:
a lid selectively engaging the bucket.

16. A method of using an integrated system comprising:
providing:
a first handle and a second handle;
a first container attached to the first handle and a second container attached to the second handle;
wherein the second container comprises a plurality of openings;
a first lip portion, having a first side and a second side, around a perimeter of the first handle and first container;
a second lip portion, having a first side and a second side, around a perimeter of the second handle and second container;
placing the second container into the first container;
engaging the first handle with the second handle; and,
mating the first side of the first lip portion with the second side of the second lip portion.

17. The method of claim 16, further comprising:
placing food into the second container;
draining liquid from the food through the plurality of openings; and,
removing the second container from the first container.

18. The method of claim 17, before the step of draining liquid from the food further comprising:
providing a hand-operated pressing mechanism;
placing the hand-operated pressing mechanism over the food; and
pushing the hand-operated pressing mechanism into the second container.

19. A method of using an integrated system comprising:
providing:
a first handle and a second handle;
a first container attached to the first handle and a second container attached to the second handle;
wherein the second container comprises a plurality of openings;
a first lip portion, having a first side and a second side, around perimeter of the first handle and first container;
a second lip portion, having a first side and a second side, around a perimeter of the second handle and second container;
placing food into the first container; and
mating the first side of the second lip portion with the first side of the first lip portion.

20. The method of claim 19, further comprising:
holding the first handle against the second handle;
inverting the first container and the second container;
transferring the food and liquid from the first container to the second container; and
draining the liquid from the food and second container through the plurality of openings.
